(19) United States
(12) Patent Application Publication
(10) Pub. No.: US 2014/0006495 A1
(43) Pub. Date: Jan. 2, 2014

(54) AUTHORIZING ACCESS TO A WEB CONFERENCE FOR A SPECIFIED DURATION OF TIME

(71) Applicants: DARRYL M. ADDERLY, MORRISVILLE, NC (US); MICHELLE DAVIS, RALEIGH, NC (US); DALE J. HEEKS, CARY, NC (US)

(72) Inventors: DARRYL M. ADDERLY, MORRISVILLE, NC (US); MICHELLE DAVIS, RALEIGH, NC (US); DALE J. HEEKS, CARY, NC (US)

(73) Assignee: INTERNATIONAL BUSINESS MACHINES CORPORATION, ARMONK, NY (US)

(21) Appl. No.: 13/537,521

(22) Filed: Jun. 29, 2012

(51) Int. Cl. G06F 15/16

(52) U.S. Cl. 709/204

(57) ABSTRACT

Authorizing access to a Web conference can include defining a plurality of groups of participants of the Web conference, wherein the Web conference is scheduled for a conference duration, and defining a plurality of sessions of the Web conference, using a processor. Each session is associated with a group of the plurality of groups and has a duration that is a subset of the conference duration. Each group is permitted access to the Web conference only for the session associated with the group.

### BACKGROUND

A Web conference is a meeting that is conducted over a network in which each participant accesses the Web conference using a client system such as a computer, a mobile communication device, or the like. The Web conference typically is live and includes the distribution of visual and/or audio data from one or more participant client systems to one or more other participant client systems. A centralized Web conferencing system coordinates the exchange of data among participants during the Web conference.

Often, multiple Web conferences are scheduled back to back. One Web conference is scheduled to start immediately following another, prior Web conference. For example, a first Web conference may begin at 1:00 p.m. and end at 1:30 p.m., while a second Web conference begins at 1:30 p.m. and ends at 2:00 p.m. If the first Web conference runs later than anticipated and ends at a time that is after 1:30 p.m., the participants of the second Web conference may access the Web conferencing system and be inadvertently joined to the first Web conference still in progress. Thus, the participants of the second Web conference may be exposed to subject matter that the participants were not authorized or intended to view.

### BRIEF SUMMARY

One or more embodiments disclosed within this specification relate to Web conferencing and, more particularly, to authorizing participant access to a Web conference for specified durations of time.

An embodiment can include a method. The method can include defining a plurality of groups of participants of a Web conference, wherein the Web conference is scheduled for a conference duration, and defining a plurality of sessions of the Web conference, using a processor. Each session is associated with a group of the plurality of groups and has a duration that is a subset of the conference duration. Each group is permitted access to the Web conference only for the session associated with the group.

Another embodiment can include a system having a processor. The processor can be configured to initiate executable operations including defining a plurality of groups of participants of a Web conference, wherein the Web conference is scheduled for a conference duration, and defining a plurality of sessions of the Web conference. Each session is associated with a group of the plurality of groups and has a duration that is a subset of the conference duration. Each group is permitted access to the Web conference only for the session associated with the group.

Another embodiment can include a computer program product. The computer program product can include a computer readable storage medium having stored thereon program code that, when executed, configures a processor to initiate executable operations including defining a plurality of groups of participants of a Web conference, wherein the Web conference is scheduled for a conference duration, and defining a plurality of sessions of the Web conference. Each session is associated with a group of the plurality of groups and has a duration that is a subset of the conference duration. Each group is permitted access to the Web conference only for the session associated with the group.

### BRIEF DESCRIPTION OF THE SEVERAL VIEWS OF THE DRAWINGS

FIG. 1 is a block diagram illustrating a Web conferencing environment in accordance with an embodiment disclosed within this specification.

FIG. 2 is a block diagram illustrating an exemplary implementation of the Web conferencing system of FIG. 1 in accordance with another embodiment disclosed within this specification.

FIG. 3 is a flow chart illustrating a method of Web conferencing in accordance with another embodiment disclosed within this specification.

FIG. 4 is a flow chart illustrating a method of Web conferencing in accordance with another embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more embodiments disclosed within this specification relate to Web conferencing and, more particularly, to authorizing participant access to a Web conference for specified durations of time. A Web conference is a meeting that is conducted over a network in which each participant accesses the Web conference via a client system such as a computer, a mobile communication device, or the like. The Web conference typically is live and includes the exchange of visual and/or audio data between one or more participant client systems as coordinated and managed by a centralized Web conferencing system. In some cases, the audio data is distributed as part of the Web conference by the Web conferencing system. In other cases, however, audio is not distributed, or only distributed to selected participants by the Web conferencing system. Those not receiving audio via the Web conferencing system obtain audio via a call-in telephone number, e.g., a teleconference, provided as a companion to the Web conference.

In accordance with the inventive arrangements disclosed within this specification, multiple sessions can be established within a Web conference. Each of the sessions can be assigned a particular duration of time that is a subset of the duration of time of the Web conference. The participants of the Web conference can be organized into one or more groups, with each group being correlated with a session.

By permitting each participant to access the Web conference only for the particular session that is associated with the participant, e.g., by way of group membership and correlation between sessions and groups, multiple sessions can be conducted for a single Web conference. Participants of one session of the Web conference are able to access the Web conference only for their session and are not able to access the Web conference for a different session. In this manner, participants are not exposed to subject matter from another, different session of the same Web conference unless intended as described within this specification.

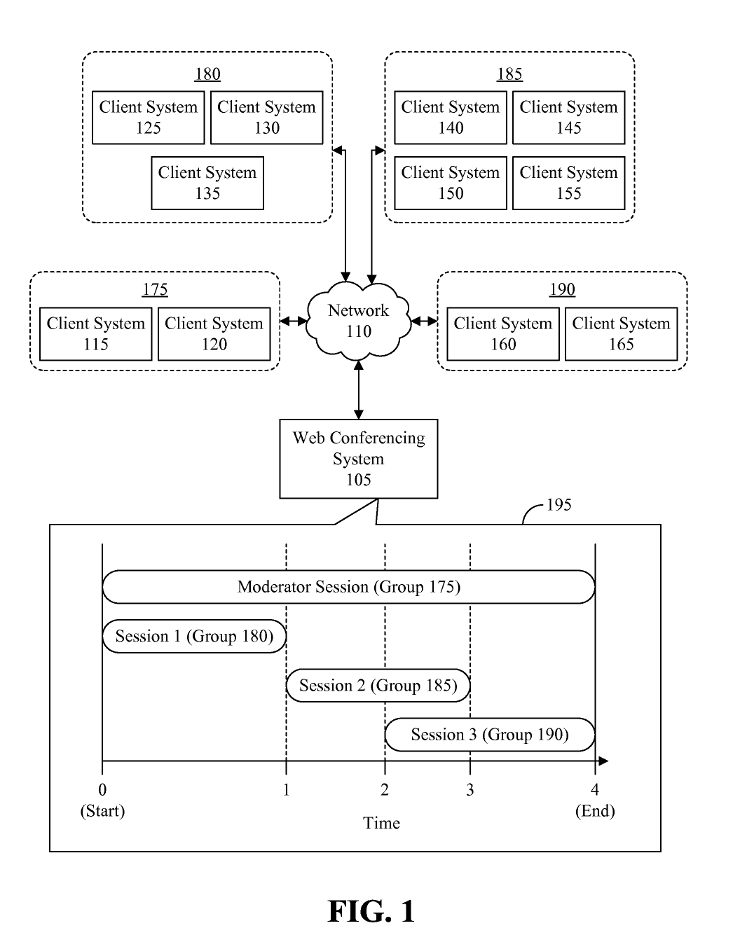

FIG. 1 is a block diagram illustrating a Web conferencing environment in accordance with an embodiment disclosed within this specification. As shown, a Web conferencing system (system) 105 is coupled to a plurality of client systems through a network 110. System 105 is implemented as a data processing system that is configured to perform Web conferencing operations as described within this specification. In one aspect, system 105 represents a single data processing system, e.g., a server. In another aspect, system 105 represents a collection of two or more interconnected data processing systems.

Network 110 represents any of a variety of communication networks or a combination of two or more communication networks coupled together. For example, network 110 can be implemented as, or include, a Wide Area Network, a local area network, a wireless network, a mobile network, the Internet, or various combinations thereof, to which data processing systems (e.g., mobile devices, communication devices, computers, etc.) can be coupled.

As shown, the Web conference environment illustrated in FIG. 1 includes a plurality of client systems 115-165. Each of client systems 115-165 represents a data processing system through which a user, e.g., a participant, can interact with and/or participate in a Web conference that is conducted by system 105.

As participants of a Web conference must access the Web conference through a particular device, e.g., a client system, reference to a participant of a Web conference within this specification also refers to the client system of the participant. Similarly, reference to a particular client system also references the participant (e.g., operator of the client system). The terms “client system” and “participant” are used interchangeably from time to time within this specification with the understanding that a notification and/or other data directed to, or received from, a particular client system is also directed to, or received from, the particular participant of the client system. Similarly, a notification and/or other data directed to, or received from, a particular participant is also directed to, or received from the particular client system of the participant.

Client systems 115-165 are organized into a plurality of different groups. Client systems 115 and 120 belong to group 175. Client systems 125-135 belong to group 180. Client systems 140-155 belong to group 185. Client systems 160-165 belong to group 190. The particular number of client systems within a group as illustrated in FIG. 1 is for purposes of illustration only. A group can include a single client system or more than shown. As such, the particular number of client systems within a given group is not intended as a limitation of the one or more embodiments disclosed within this specification. Similarly, the number of groups illustrated within FIG. 1 is for purposes of illustration only and is not intended as a limitation of the one or more embodiments disclosed within this specification.

In general, each group of client systems is associated with a session of a Web conference. The Web conference is scheduled to take place for a specified duration of time referred to as the conference duration. The conference duration has a start time referred to as the conference start time and an end time referred to as the conference end time. Each session of the Web conference also is associated with a duration of time that is a subset of the conference duration. A moderator, or moderators, of the Web conference can organize the Web conference and define groups, sessions, and the like for the Web conference.

Referring again to FIG. 1, a Web conference 195 is conducted by system 105 and is visually illustrated. Time is illustrated on the horizontal axis and increases from left to right. Web conference 195 includes multiple different sessions. Web conference 195 includes a moderator session that is scheduled for the conference duration. For purposes of illustration, the conference duration can begin at time 0 and end at time 4. Thus, the moderator session lasts from time 0 to time 4.

In this example, group 175 is a moderator group. As such, each client system, i.e., client systems 115 and 120, that are members of group 175 are moderators. As shown, group 175 is correlated with, or assigned to, the moderator session. A moderator is a participant of Web conference 195 that has one or more additional rights relating to the creation and/or modification of Web conference 195, which includes the creation and/or modification of groups and/or sessions. Whereas a non-moderator participant, referred to as a participant, is permitted access to only a subset of the conference duration, a moderator is permitted access for the entirety of the conference duration. As shown, the moderator session lasts for the entirety of the conference duration.

Group 180 is correlated with session 1. Session 1 has a duration that begins at time 0 and ends at time 1. Group 185 is correlated with session 2. Session 2 has a duration that begins at time 1 and ends at time 3. Group 190 is correlated with session 3. Session 3 has a duration that begins at time 2 and ends at time 4. In this example, session 2 and session 3 overlap. In another example, however, each session can be scheduled for a mutually exclusive and non-overlapping duration. The particular duration for a session can be referenced within this specification using the session name and/or the group. For example, the duration beginning at time 1 and ending at time 3 can be referred to as “group 185 duration,” “the duration for group 185,” the “duration of session 2,” or simply as “session 2”. Appreciably, as groups are correlated, or assigned to, sessions, and sessions have a specified duration, the terms “duration” and “session” may be used interchangeably from time to time within this specification.

In operation, system 105 allows participants that are members of the moderator group, i.e., client systems 115 and 120 of group 175, access to Web conference 195 for the entire duration of Web conference 195, e.g., for the entire conference duration. By comparison, other sessions of the Web conference last for only a subset of the conference duration. Each respective group is permitted access to Web conference 195 only for, or during, the particular duration of the session correlated with the group.

Thus, system 105 permits clients 125-135, being members of group 180, to access Web conference 105 only during group 180 duration (session 1). System 105 permits clients 140-155, being members of group 185, to access Web conference 105 only during group 185 duration (session 2). Finally, system 105 permits clients 160-165, being members of group 190, to access Web conference 105 only during group 190 duration (session 3).

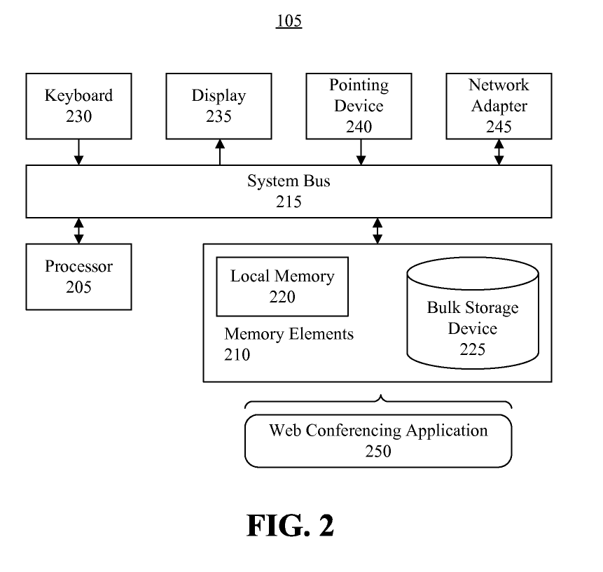

FIG. 2 is a block diagram illustrating an exemplary implementation of system 105 of FIG. 1 in accordance with another embodiment disclosed within this specification. Like numbers will be used to refer to the same items throughout this specification.

System 105 can include at least one processor 205 coupled to memory elements 210 through a system bus 215 or other suitable circuitry. As such, system 105 can store program code within memory elements 210. Processor 205 can execute the program code accessed from memory elements 210 via system bus 215.

In one aspect, for example, system 105 can be implemented as a computer that is suitable for storing and/or executing program code. It should be appreciated, however, that system 105 can be implemented in the form of any system including a processor and memory that is capable of performing the functions and/or operations described within this specification.

Memory elements 210 can include one or more physical memory devices such as, for example, local memory 220 and one or more bulk storage devices 225. Local memory 220 refers to RAM or other non-persistent memory device(s) generally used during actual execution of the program code. Bulk storage device(s) 225 can be implemented as a hard disk drive (HDD), solid state drive (SSD), or other persistent data storage device. System 105 also can include one or more cache memories (not shown) that provide temporary storage of at least some program code in order to reduce the number of times program code must be retrieved from bulk storage device 225 during execution.

Input/output (I/O) devices such as a keyboard 230, a display 235, and a pointing device 240 optionally can be coupled to system 105. The I/O devices can be coupled to system 105 either directly or through intervening I/O controllers. One or more network adapters 245 also can be coupled to system 105 to enable system 105 to become coupled to other systems, computer systems, remote printers, and/or remote storage devices through intervening private or public networks. Modems, cable modems, and Ethernet cards are examples of different types of network adapters 245 that can be used with system 105.

As pictured in FIG. 1, memory elements 210 can store a Web conferencing application 250. Web conferencing application 250, being implemented in the form of executable program code, can be executed by system 105 and, as such, can be considered part of system 105. System 105, executing Web conferencing application 250, is configured to initiate and/or perform the various operations described within this specification.

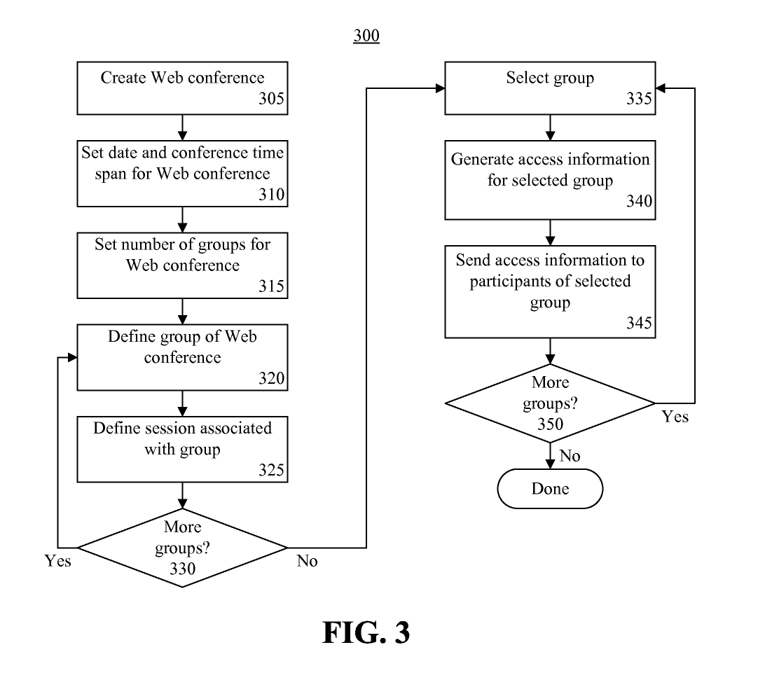

FIG. 3 is a flow chart illustrating a method 300 of Web conferencing in accordance with another embodiment disclosed within this specification. Method 300 can be implemented by a system as described with reference to FIGS. 1 and 2 and illustrates an exemplary process for setting up a Web conference in accordance with the one or more embodiments disclosed within this specification.

Method 300 can begin in block 300 in which a Web conference can be created. For example, responsive to one or more inputs received from a user that is to be a moderator, the system can create the Web conference. In block 310, the system can set a conference duration for the Web conference. For purposes of description, the conference duration of the Web conference, in addition to specifying a conference start time and a conference end time, also specifies a date on which the Web conference is to occur. Referring to block 310, for example, the system can set the conference duration for the Web conference responsive to one or more received inputs from a moderator specifying such information. In block 315, the system can set the number of groups for the Web conference. Again, the system can set the number of groups for the Web conference responsive to an input received from the moderator specifying the number of groups that are to participate in the Web conference.

Beginning in block 320, the system can begin creating the various groups that are to participate in the Web conference and the sessions with which each group is associated. In one aspect, groups are correlated with sessions on a one-to-one basis. Accordingly, in block 320, the system can define a group of the Web conference. Responsive to an input from a moderator requesting creation of a group, the system, for example, can query the moderator for one or more participants, e.g., identities, that are to be members of the group. Once provided, the system adds the participants as members of the particular group that is being defined and/or created in block 320.

In block 325, the system can define a session for the Web conference. The session that is defined is associated with the group created in block 320. For example, the system can receive an input from the moderator specifying a start time and an end time for the duration of the session. As discussed, the duration for a session is a subset of the conference duration. While the duration for a given session (and thus group) can start or end at the same time as the conference duration, the duration for a session will not start and end at the same time as the conference duration. In one aspect, only the moderator session has the same start time and end time as the conference duration. As noted, the durations for sessions can be mutually exclusive, i.e., non-overlapping, or can be overlapping according to moderator preference.

In block 330, the system can determine whether any further groups are to be defined based upon the number of groups specified in block 315 and the number of groups already defined. If more groups are to be defined, method 300 loops back to block 320 to continue defining groups and associated sessions. If no further groups are to be defined, method 300 continues to block 335.

In block 335, the system can select a group from those defined for the Web conference. In block 340, the system can generate access information for the selected group. The system generates one or more session identifiers as access information for the Web conference. Each session identifier can be implemented as a Universal Resource Identifier (URI) through which a participant can access the Web conference.

In one embodiment, the session identifier can be unique to the group so that each group (and thus session) has a different and unique session identifier. In a further embodiment, the session identifiers are hierarchical in nature. The session identifier for the moderator group is a parent session identifier, e.g., a root node, while the session identifier for each other group (e.g., a non-moderator group) is a child session identifier of the parent session identifier. Each child session identifier has access to the duration corresponding to the parent session identifier, which is the conference duration in this case.

In another embodiment, the session identifier is not unique to the group. For example, each group can utilize a same URI for accessing the Web conference. The system can generate a password as part of the access information. The password, unlike the session identifier, is unique to the group and is therefore a group specific password.

In block 345, the system can send the access information generated for the selected group to each participant of the group. Depending upon the particular access information that is generated, each participant can receive, or be notified, of a session identifier and, optionally, a password if generated. The access information can be provided to a participant using any of a variety of different methods. For example, the system can send the access information to a participant via electronic mail, text or instant message, etc. In sending the access information, the notification also can specify the particular duration for the session in which each participant is to take part in the Web conference.

In block 350, the system can determine whether access information is to be generated for one or more groups. If so, method 300 can loop back to block 335 to generate further access information for a next selected group as described. If not, method 300 can end.

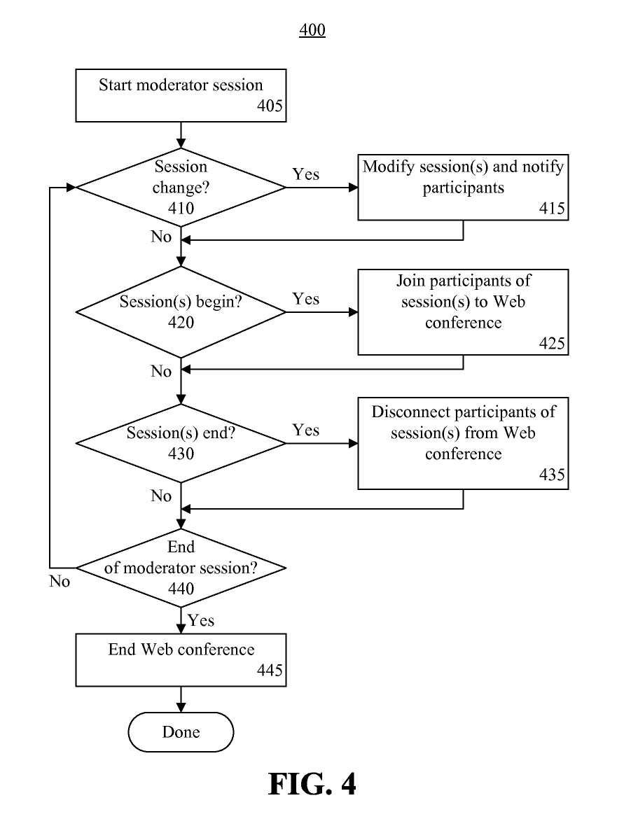

FIG. 4 is a flow chart illustrating a method 400 of Web conferencing in accordance with another embodiment disclosed within this specification. Method 400 can be implemented by a system as described with reference to FIGS. 1-3 and illustrates an exemplary process for conducting a Web conference in accordance with the one or more embodiments disclosed within this specification.

As described with reference to FIG. 3, each participant is provided with access information for the Web conference. At or near the particular time for a session of a participant, the participant selects the session identifier and is directed, e.g., using a browser, to a Web page for the Web conference. When the session identifier is group specific, the participant is directed to a Web page that is specific for the group to which the participant belongs. When the session identifier is not group specific, the participant is directed to a general Web page for the Web conference.

In any case, once a user navigates to a Web page for the Web conference, the user is authenticated to the system. The authentication can be performed using a name of the participant, an electronic mail address of the user, a username, and/or a password, etc., depending upon the particular access information provided to the participant and the authentication method selected for use by the system.

When a participant user is “joined” to the Web conference, the joining is predicated upon a successful authentication of the participant to the system. Once joined, the client system of the participant is permitted to receive visual data and/or audio data for the conference and submit visual and/or audio data to the conference for access by other participants as permitted and/or defined by the moderator(s). Accordingly, for purposes of description and ease of illustration, it should be appreciated that in order for a participant to join the Web conference, or a given session of the Web conference, the participant has accessed a Web page for the Web conference and been successfully authenticated by the system.

Accordingly, method 400 can begin in a state where a Web conference has been created as described with reference to FIG. 3 and is starting. For example, the conference start time is detected, or determined, as a current time the system. Method 400 can begin in block 405, where the system starts the moderator session. Thus, in block 405, the system joins any moderators of the Web conference, as described, to the Web conference. It should be appreciated that moderators of a Web conference that is in progress further are permitted to join the Web conference and are joined, by the system, when authenticated while the session is in progress.

In block 410, the system can determine whether any changes to one or more sessions of the Web conference have been received or otherwise specified by a moderator. If so, method 400 can proceed to block 415. If not, method 400 can continue to block 420. For example, a moderator can provide an input to the system that changes the start and/or end time of one or more sessions of the Web conference. Responsive to receiving such an input, method 400 can proceed to block 415. In another example, the moderator can provide an input to the system that changes the particular participants that belong to one or more groups.

In block 415, the system adjusts the session(s) as indicated by the received input from the moderator. As noted, the start time of one or more sessions can be changed and/or the end time of one or more sessions can be changed. In another aspect, the moderator can add or remove participants from a group, move one or more participants from one group to another different group, etc.

Also in block 415, the system notifies participants of the modification to the session(s). In one embodiment, for each modified session, the system notifies each participant of the group associated with the modified session and indicates the particular modification that was made. In one example, the system can send an electronic mail or other message to the participant(s) that are to attend the modified session(s) informing each of the modification. In another example, the system can include a message on the Web page to which each participant of a modified session is directed. The Web page can automatically update, for example, to obtain the message about the modified session(s). The message can be displayed on a group specific Web page or a generalized Web page accessed by multiple ones of the groups.

In another embodiment, the system can notify participants of the particular session that is being extended. For example, the system can display a message in the Web conference itself, e.g., a message displayed in a window or sub-window of the application used by the participant to access the Web conference indicating that the session has been extended and/or indicating a new ending time of the session.

It should be appreciated that the Web conference can be modified by a moderator prior to the Web conference if so desired. In that case, notifications can be sent to any participants with changed access information. The example described with reference to FIG. 4 is intended to demonstrate the dynamic agility of the system to adapt to changing sessions while the Web conference continues in real time, e.g., live.

Continuing with block 420, the system determines whether any of the sessions that are not moderator sessions of the Web conference have started. If so, method 400 proceeds to block 425. If not, method 400 continues to block 430. In block 425, the system permits each participant of the session that has started to join the Web conferencing system. In one aspect, each participant can remain at the Web page specified by the session identifier received by that participant until such time that the system joins the participant to the Web conference. Accordingly, any participants for the started session that have been authenticated are joined to the Web conference. Further, the system permits participants to join, and joins the participants, to the Web conference responsive to authentication while the session of the participant(s) remains in progress.

In another aspect, as a moderator makes changes to membership of a group, such changes can be acted upon responsive to the change of membership while the Web conference is in progress. For example, a participant that is joined to the Web conference for a session that is in progress can be disconnected from the Web conference responsive to a moderator removing that participant from the group, whether removed permanently or removed and added to another different group (and thus session). Similarly, a user added to a group, whether newly added or moved into the group from another, can be joined to the Web conference when, or while, the session for the participant is in progress responsive to authentication.

In block 430, the system can determine whether any session, session(s), not a moderator session, has ended or expired. If so, method 400 can proceed to block 435. If not, method 400 can continue to block 440. In block 435, the system can disconnect each participant of the session, or session(s), that have ended or expired.

In block 440, the system can determine whether the moderator session has ended. If so, method 400 can proceed to block 445. If not, method 400 loops back to block 410 to continue processing as described. In block 445, the system ends the Web conference. Ending the Web conference disconnects each participant, e.g., moderator or otherwise, from the Web conference and discontinues any distribution and/or sharing of visual and/or audio data among participants.

The inventive arrangements disclosed within this specification facilitate the use of multiple sessions within a single Web conference. Participants of each respective session are only permitted to join the Web conference for the particular time span, e.g., duration, associated with that participant. Accordingly, participants can be prevented from accessing particular portions of a Web conference and inadvertently obtaining access to materials distributed through the Web conference not intended for that participant.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method, comprising:
defining a plurality of groups of participants of a Web conference, wherein the Web conference is scheduled for a conference duration;
defining a plurality of sessions of the Web conference, using a processor, wherein each session is associated with a group of the plurality of groups and has a duration that is a subset of the conference duration; and
permitting each group access to the Web conference only for the session associated with the group.

2. The method of claim 1, wherein the plurality of groups includes a moderator group comprising at least one moderator, and wherein the moderator group has access to the Web conference for the conference duration.

3. The method of claim 1, wherein the plurality of groups comprises a first group associated with a first session and a second group associated with a second session, wherein the first session has a first duration and the second session has a second duration that is different from the first duration.

4. The method of claim 3, further comprising:
permitting participants of the first group access to the Web conference only for the first duration; and
permitting participants of the second group access to the Web conference only for the second duration.

5. The method of claim 1, further comprising:
responsive to a moderator input, modifying a session of the Web conference.

6. The method of claim 5, wherein the modifying a session of the Web conference is performed during the conference duration.

7. The method of claim 5, further comprising:
notifying each participant of the group associated with the modified session.

8. The method of claim 1, further comprising:
sending each participant of the Web conference a group specific session identifier through which the participant accesses the Web conference.

9. The method of claim 8, further comprising:
joining a selected participant to the Web conference responsive to authenticating the selected participant and determining that the session for the selected participant has started.

10. The method of claim 9, further comprising:
disconnecting the selected participant from the Web conference responsive to expiration of the session for the selected participant.

11. A system comprising:
a processor configured to initiate executable operations comprising:
defining a plurality of groups of participants of a Web conference, wherein the Web conference is scheduled for a conference duration;
defining a plurality of sessions of the Web conference, wherein each session is associated with a group of the plurality of groups and has a duration that is a subset of the conference duration; and
permitting each group access to the Web conference only for the session associated with the group.

12. The system of claim 11, wherein the plurality of groups includes a moderator group comprising at least one moderator, and wherein the moderator group has access to the Web conference for the conference duration.

13. The system of claim 11, wherein the plurality of groups comprises a first group associated with a first session and a second group associated with a second session, wherein the first session has a first duration and the second session has a second duration that is different from the first duration.

14. The system of claim 13, wherein the processor is further configured to initiate executable operations comprising:
permitting participants of the first group access to the Web conference only for the first duration; and
permitting participants of the second group access to the Web conference only for the second duration.

15. The system of claim 11, wherein the processor is further configured to initiate executable operations comprising:
responsive to a moderator input, modifying a session of the Web conference; and
notifying each participant of the group associated with the modified session.

16. A computer program product, comprising:
a computer readable storage medium having stored thereon program code that, when executed, configures a processor to initiate executable operations comprising:
defining a plurality of groups of participants of a Web conference, wherein the Web conference is scheduled for a conference duration;
defining a plurality of sessions of the Web conference, wherein each session is associated with a group of the plurality of groups and has a duration that is a subset of the conference duration; and
permitting each group access to the Web conference only for the session associated with the group.

17. The computer program product of claim 16, wherein the plurality of groups includes a moderator group comprising at least one moderator, and wherein the moderator group has access to the Web conference for the conference duration.

18. The computer program product of claim 16, wherein the plurality of groups comprises a first group associated with a first session and a second group associated with a second session, wherein the first session has a first duration and the second session has a second duration that is different from the first duration.

19. The computer program product of claim 18, wherein the computer readable storage medium further stores program code that, when executed, configures a processor to initiate executable operations comprising:
permitting participants of the first group access to the Web conference only for the first duration; and
permitting participants of the second group access to the Web conference only for the second duration.

20. The computer program product of claim 16, wherein the computer readable storage medium further stores program code that, when executed, configures a processor to initiate executable operations comprising:
responsive to a moderator input, modifying a session of the Web conference; and
notifying each participant of the group associated with the modified session.
